(19) United States
(12) Patent Application Publication
(10) Pub. No.: US 2019/0071284 A1
(43) Pub. Date: Mar. 7, 2019

(54) ELEVATOR CABIN ASSEMBLY AND ELEVATOR SYSTEM

(71) Applicant: FUNICULATOR AB, Stockholm (SE)

(72) Inventor: Fritz KING, Stockholm (SE)

(21) Appl. No.: 16/070,625

(22) PCT Filed: Dec. 22, 2016
(86) PCT No.: PCT/SE2016/051313

§ 371 Date: Jul. 17, 2018

(30) Foreign Application Priority Data
Jan. 18, 2016 (SE) 1650054-8

(51) Int. Cl. B66B 11/02; B66B 9/00

(52) U.S. Cl. CPC B66B 11/0226; B66B 11/0206; B66B 2201/308; B66B 2009/006; B66B 9/003

(57) ABSTRACT

Cabin assembly (10) for an elevator system, the cabin assembly (10) comprises a cabin (12), a chassis (14) configured to rotationally support the cabin (12) about a cabin axis (16) extending through the cabin (12), a circular thrust profile (18) arranged on the cabin (12) substantially concentric to the cabin axis (16), and a drive member (68) configured to engage the thrust profile (18) to rotate the cabin (12) about the cabin axis (16).

### TECHNICAL FIELD

The present disclosure generally relates to a cabin assembly for an elevator system. In particular, a cabin assembly for an elevator system and an elevator system comprising the cabin assembly are provided.

### BACKGROUND

Various types of elevator systems for vertically transporting people and/or goods are known. Some elevator systems include a rotatably supported cabin such that the cabin can be maintained in a horizontal orientation as the cabin transitions between horizontal and vertical track portions.

WO 2009125253 A1 discloses a transportation system for high-rise buildings with self-propelled cabins. A big gear is firmly attached to a supporting element while smaller gears are arranged on the top of the cabin. Interlocking of the gears makes it possible to control the tilt of the cabin.

The Articulated Funiculator® is a new concept of vertical transportation which is described in WO 2013159800 A1. This transportation system may be used in tall buildings, deep underground subway stations and deep mines.

The concept of the Articulated Funiculator® opens up for the use of a wide range of track configurations. For example, practically endless combinations of straight, curved, inclined and helical track sections may be used. For these track configurations, the tilt control according to WO 2009125253 A1 is not appropriate.

### SUMMARY

Accordingly, one object of the present disclosure is to provide a cabin assembly with a simple, reliable, fast and accurate rotation of a cabin.

According to one aspect, a cabin assembly for an elevator system is provided, where the cabin assembly comprises a cabin, a chassis configured to rotationally support the cabin about a cabin axis extending through the cabin, a circular thrust profile arranged on the cabin substantially concentric to the cabin axis and a drive member configured to engage the thrust profile to rotate the cabin about the cabin axis. The thrust profile and the drive member may be spaced along the cabin axis or spaced along an axis perpendicular to the cabin axis.

The cabin assembly may be configured such that the cabin axis is substantially perpendicular to a yaw axis of the cabin when the cabin assembly is in an operational state on a track of an elevator system. The cabin may have an outer profile that is substantially rotation symmetric with respect to the cabin axis. Alternatively, the cabin may have a polygonal outer profile. For example, the cabin may have a substantially cuboid appearance. The cabin, the thrust profile and/or the chassis may be injection moulded.

The cabin assembly may comprise one or several circular thrust profiles arranged on the cabin. For example, the cabin assembly may comprise two circular thrust profiles arranged substantially concentric to the cabin axis. One or several drive members may be provided and configured to engage a respective thrust profile to rotate the cabin about the cabin axis. Each thrust profile may be integrally formed with the cabin or attached to the cabin.

Throughout the present disclosure, the cabin may alternatively be referred to as a carriage, pod or car and the chassis may alternatively be referred to as a support structure or support member.

A substantially concentric arrangement of the circular thrust profile with respect to the cabin axis is intended to include designs where the cabin axis is displaced up to 0.5 times, such as up to 0.2 times, such as up to 0.1 times, such as up to 0.05 times the length of an imaginary radius of the thrust profile measured from an imaginary centre point of an imaginary circle coinciding with the thrust profile. A corresponding definition is applicable to define the location of a cabin axis extending substantially through a geometrical centre of the cabin, see below.

The circular thrust profile may or may not be continuous. According to one variant, the thrust profile fully encircles the cabin axis, i.e. the thrust profile is continuous and has an angular extension about the pitch axis of 360°. According to alternative variants, the thrust profile has a circular appearance concentric with the cabin axis but does not fully encircle the cabin axis (i.e. a discontinuous thrust profile). For example, the thrust profile may have an angular extension about the pitch axis of 10°, 15°, 30°, 45°, 90°, 180° or 270°.

The rotation of the cabin may be used to maintain a cabin floor in a substantially horizontal orientation. However, the rotation may also be used to pitch the cabin in order to reduce horizontal forces on the passengers during horizontal accelerations and decelerations, i.e. to reduce the horizontal inertia forces on the passengers (or loads) during stops and starts.

The cabin axis may or may not be constituted by a pitch axis, i.e. an axis perpendicular to a roll axis and a yaw axis when the cabin assembly is in an operational state on a track of an elevator system. That is, in case the chassis is also configured to rotationally support the cabin about a yaw axis, the cabin axis may not always constitute the pitch axis.

Each cabin assembly according to the present disclosure may further comprise a yaw support member configured to be coupled to the track of an elevator system for movement along the track and configured to rotatably support the chassis for rotation about the yaw axis.

The cabin assembly may further comprise a track coupling arrangement for movement along an elevator track. The track may include a single rail or several rails. One suitable track is constituted by a pair of rails. The track may contain a wide range of combinations of straight, curved and inclined sections. The track may also contain helical or twisted sections such that the cabin assembly can roll in space as its moves along the track. The track coupling arrangement may comprise at least one wheel assembly for engaging a rail portion of the track to move along the track.

The cabin assembly according to the present disclosure is not limited to any particular type of propulsion system. For example, all cabin assemblies in the elevator system may be driven by a cable or set of cables or each carriage may have an individual propulsion system. Two or more different types of propulsion systems may also be combined in the elevator system.

According to one variant, the cabin axis may extend substantially through a geometrical centre of the cabin. For example, in case the cabin has a substantially cylindrical appearance (e.g. barrel shape), the cabin axis may be constituted by the axis of the cylinder.

The thrust profile and the drive member may be spaced along the cabin axis. The thrust profile may be a circular disc substantially concentric with the cabin axis. The circular disc may thus be referred to as a thrust disc.

The thrust profile may protrude radially outwards from the cabin with respect to the cabin axis. Alternatively, the thrust profile may be arranged at an end of the cabin along the cabin axis. As an example, the cabin assembly may comprise two thrust profiles, one at each end of the cabin.

The cabin assembly may further comprise at least one bearing member to allow a relative rotation of the cabin and the chassis about the cabin axis. The bearing member may be constituted by a roller bearing, a frictional bearing (by providing a low frictional material such as plastics to one or both of the bearing surfaces), a fluid bearing or an electromagnetic bearing.

Each bearing member may be associated with a thrust profile. For example, the cabin assembly may comprise two trust profiles and two bearing members associated with the thrust profiles. Each bearing member may further be distanced from an associated thrust profile, e.g. distanced along the rotational axis or in a radial direction.

According to one variant, the cabin assembly comprises two cabins and the chassis is at least partly arranged between the two cabins. In other words, the chassis is connected to the cabins between the cabins. For example, the chassis may comprise a support member constituting a hub. A rod member, interconnecting the two cabins, may be rotationally held by the support member to allow the cabins to jointly rotate about the cabin axis. The chassis is thereby configured to rotationally support both cabins for rotation about the cabin axis.

The thrust profile and the drive member may constitute a stator and a rotor of an electric motor. The drive member may be a stator provided with coils for producing a magnetic field and the thrust profile may be a rotor provided with magnets for being driven by the magnetic field.

The drive member may comprise at least one toothed gear configured to engage the thrust profile to rotate the cabin about the cabin axis. The thrust profile may comprise teeth configured to be engaged by the toothed gear of the drive member. The drive member may further comprise an elongated rotatable drive shaft on which the toothed gear is provided. In an operational state of the cabin assembly, the drive shaft may be oriented substantially parallel with, or concentric with, the yaw axis.

The thrust profile and the drive member may comprise bevel gears. Alternatively, the thrust profile may comprise a larger gear wheel having teeth facing substantially radially outwards with respect to the cabin axis and the drive member may comprise a smaller gear wheel with a rotation axis substantially parallel to the cabin axis and having teeth facing substantially radially inwards with respect to the cabin axis.

The drive member may comprise at least one friction wheel configured to engage the thrust profile to rotate the cabin about the cabin axis. In this variant, the thrust profile may be constituted by a surface facing radially outwards, for example by a surface substantially flush with the exterior profile of the cabin. Any means for increasing the friction of the thrust profile may be provided, such as the provision of a high friction rubber material on the thrust profile. The at least one friction wheel may be rotatably arranged about a friction wheel axis substantially parallel to the cabin axis.

The drive member may comprise a belt member configured to engage the thrust profile to rotate the cabin about the cabin axis. The belt member may be continuous and may form a closed loop around the thrust profile. The belt member may be of any type suitable to engage the thrust profile to rotate the cabin about the cabin axis, such as a belt comprising a rubber material.

In addition to the belt member, the drive member may comprise at least one friction wheel configured to drive the belt member. The at least one friction wheel may be rotatably arranged about friction wheel axis substantially parallel to the cabin axis. The thrust profile may be constituted by a surface facing radially outwards, for example by a surface substantially flush with the exterior profile of the cabin. Similar to the thrust profile drivable by the friction wheel, the thrust profile drivable by the belt member may be provided with any means for increasing friction.

According to a further aspect, there is provided an elevator system comprising a cabin assembly according to the present disclosure. The elevator system may for example be used in a tall building or underground to access a deep underground subway station or a deep mine. In the elevator system, the cabin axis may be arranged substantially perpendicular to a yaw axis of the cabin when the cabin assembly is in an operational state on a track of an elevator system.

The elevator system may comprise a series of separated trains, each train having a plurality of cabin assemblies according to the present disclosure, tracks on which the trains are configured to ascend and descend, the tracks constituting at least one loop configuration and at least one up-bound station and at least one down-bound station vertically separated from the up-bound station, wherein the system is configured to stop trains at each up-bound and down-bound station simultaneously for unloading and loading passengers from the cabin assemblies. This type of elevator system, the Articulated Funiculator®, is described in WO 2013159800 A1.

### BRIEF DESCRIPTION OF THE DRAWINGS

Further details, advantages and aspects of the present disclosure will become apparent from the following embodiments taken in conjunction with the drawings, wherein:

FIG. 1a: schematically represents a perspective view of a cabin assembly;

FIG. 1b: schematically represents a side view of the cabin assembly in FIG. 1a;

FIG. 2: schematically represents a side view of a further cabin assembly;

FIG. 3: schematically represents a side view of a further cabin assembly;

FIG. 4: schematically represents a side view of a further cabin assembly;

FIG. 5a: schematically represents a partial cross-sectional side view of a cabin assembly comprising an electric motor;

FIG. 5b: schematically represents a partial cross-sectional side view of a further cabin assembly comprising an electric motor;

FIG. 5c: schematically represents a partial cross-sectional side view of a further cabin assembly comprising bevel gears;

FIG. 5d: schematically represents a partial cross-sectional side view of a further cabin assembly comprising a friction wheel; and

FIG. 5e: schematically represents a partial cross-sectional side view of a further cabin assembly comprising a belt member.

### DETAILED DESCRIPTION

In the following, a cabin assembly for an elevator system and an elevator system comprising the cabin assembly will be described. The same reference numerals will be used to denote the same or similar structural features.

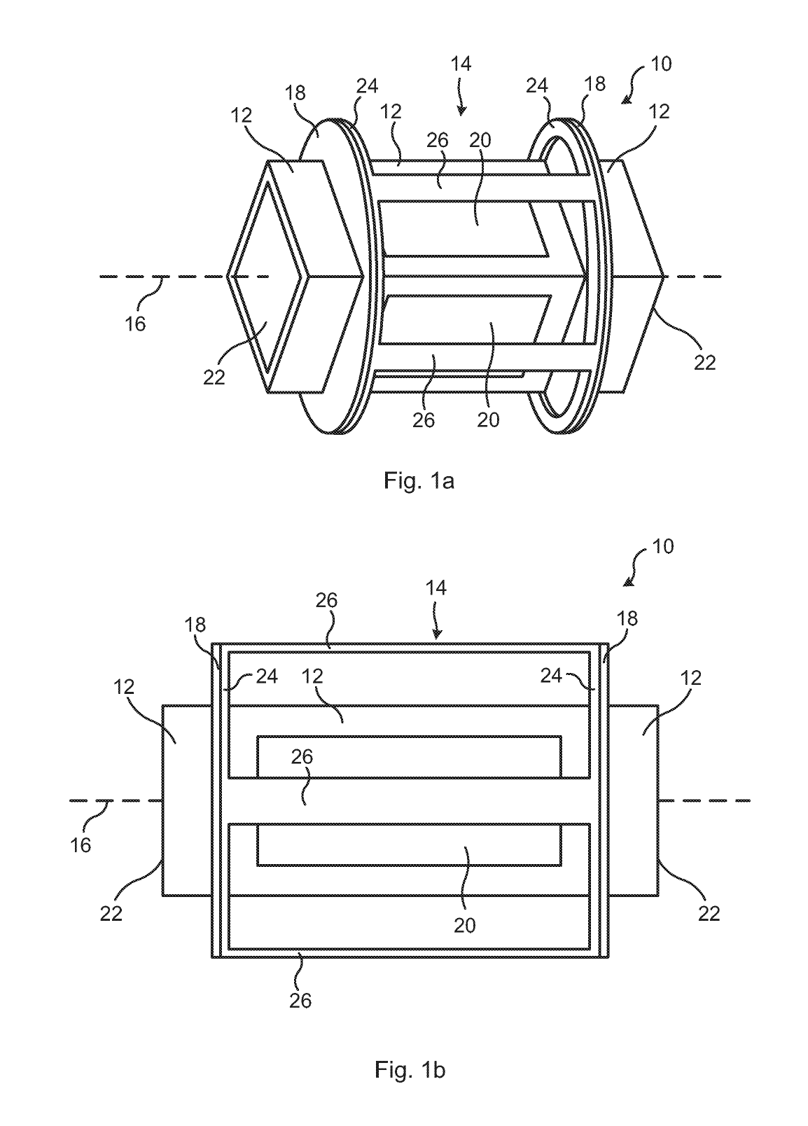

FIG. 1a schematically represents a perspective view of a cabin assembly 10 and FIG. 1b schematically represents a side view of the cabin assembly 10 in FIG. 1a. The cabin assembly 10 comprises a cabin 12 and a chassis 14. The chassis 14 is configured to rotationally support the cabin 12 about a cabin axis 16 extending through the cabin 12. In FIGS. 1a and 1b, the cabin assembly 10 is configured such that the cabin 12 can rotate 360° about the cabin axis 16.

The cabin assembly 10 further comprises two circular thrust profiles 18. Each thrust profile 18 is arranged on the cabin 12 substantially concentric to the cabin axis 16.

The thrust profiles 18 are configured to be engaged to rotate the cabin 12. In FIGS. 1a and 1b, the thrust profiles 18 are implemented as thrust discs having a flat circular appearance. The circular discs are substantially concentric with the cabin axis 16. The cabin assembly 10 also comprises two drive members (not shown) configured to engage a respective thrust profile 18 to rotate the cabin 12 about the cabin axis 16.

The cabin 12 may be configured to carry one or several passengers and/or loads. In FIGS. 1a and 1b, the cabin 12 has a substantially cuboid appearance. However, a wide range of alternative designs of the cabin 12, for example with a cylindrical appearance, are conceivable. Windows 20 (only two visible in FIG. 1a and only one visible in FIG. 1b) can be provided on three of four longitudinal sides of the cabin 12. An opening member (e.g. one or two doors) may be provided at one or both end faces 22 of the cabin 12.

The chassis 14 is constituted by a frame with a substantially cylindrical appearance. The cylindrical frame comprises two parallel rings 24 and four interconnecting struts 26. The struts 26 are substantially evenly distributed around the cabin axis 16. More or less than four struts 26 may be used to interconnect the rings 24.

FIGS. 1a and 1b further show that the cabin axis 16 is substantially coincident with the extension axis (longitudinal axis) of the cuboid shape of the cabin 12. The cabin axis 16 extends substantially through a geometrical centre of the cabin 12.

Although two circular thrust profiles 18 are illustrated in FIG. 1a, the cabin 12 may comprise only one thrust profile 18 or more than two thrust profiles 18. In case only one thrust profile 18 is provided, the thrust profile 18 may be positioned anywhere along the cabin axis 16, for example substantially flush with an end face 22 of the cabin 12 or substantially at a centre position along the longitudinal axis. In case two or more thrust profiles 18 are provided, these may be substantially evenly distributed along the longitudinal axis of the cabin 12.

This type of cabin assembly 10 comprising a cabin 12 with a cuboid appearance rotationally supported to (e.g. inside) a chassis 14 with a cylindrical appearance may be referred to as a circular pod.

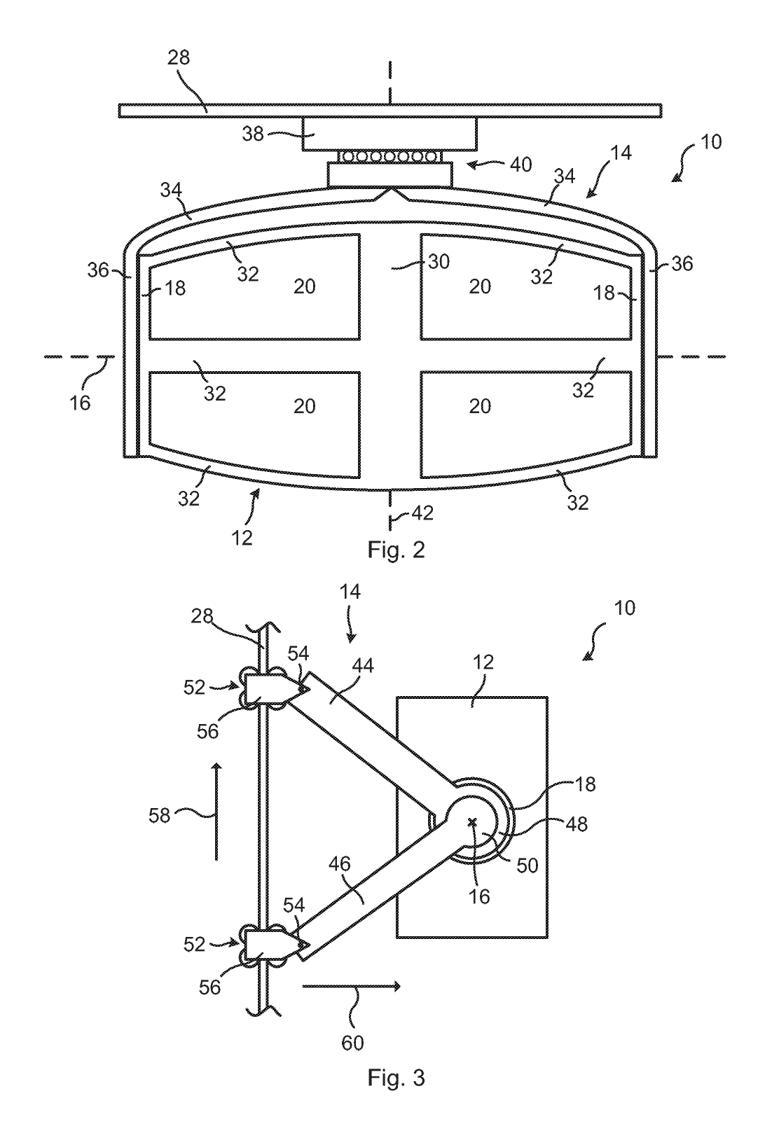

FIG. 2 schematically represents a side view of a further cabin assembly 10. The cabin assembly 10 is illustrated in an operational state on a track 28 of an elevator system. The cabin assembly 10 comprises a substantially barrel shaped cabin 12.

A circular thrust profile 18 is provided at each end face of the cabin 12. The thrust profiles 18 are constituted by circular discs substantially concentric with the cabin axis 16.

In addition to the thrust profiles 18, the cabin 12 comprises a central ring 30 and eight struts 32 (only six are visible in FIG. 2) interconnecting the thrust profiles 18 and the central ring 30. The central ring 30 may however be omitted such that the cabin 12 comprises only four struts 32 interconnecting the thrust profiles 18.

Four of totally eight windows 20 on the cabin 12 can also be seen in the side view of FIG. 2. Since the cabin 12 has a barrel shaped appearance, this cabin assembly 10 may be referred to as a barrel pod.

The cabin 12 has an outer profile that is substantially rotation symmetric with respect to the cabin axis 16. FIG. 2 further shows that the cabin axis 16 extends substantially through a geometrical centre of the cabin 12.

The chassis 14 comprises two arms 34 and a support member 36 associated with each arm 34. The arms 34 extend along the exterior profile of the cabin 12. The support members 36 are in the form of circular plates and are provided at the outer ends of the arms 34. The chassis 14 in FIG. 2 is configured to rotationally support the cabin 12 about the cabin axis 16.

Although FIG. 2 shows two arms 34, these arms 34 may replaced by one single arm. The support members 36 are arranged substantially perpendicular to the cabin axis 16.

The cabin assembly 10 in FIG. 2 further comprises a track coupling arrangement 38 and a yaw bearing member 40. The arms 34 are rotationally supported by the yaw bearing member 40 for rotation about a yaw axis 42. The yaw axis 42 is substantially perpendicular to the cabin axis 16 and to the track 28. The track coupling arrangement 38 comprises at least one wheel assembly (not shown) for engaging a rail portion of the track 28 to move along the track 28.

With the cabin assembly 10 of FIG. 2, the cabin 12 may be allowed to rotate about the yaw axis 42 and about the cabin axis 16 which is perpendicular to the yaw axis 42 (the cabin axis 16 may not always constitute the pitch axis). A drive member (not shown) is provided at each support member 36 of the chassis 14. The drive members are configured to engage the thrust profiles 18 on the cabin 12 to rotate the cabin 12 about the cabin axis 16.

FIG. 3 schematically represents a side view of a further cabin assembly 10. The cabin 12 in FIG. 3 has a vertically elongated cuboid appearance and comprises a circular thrust profile 18 in the form of a circular disc provided at one of its vertical sides. As can be seen in FIG. 3, the thrust profile 18 is arranged concentric to the cabin axis 16.

Moreover, the thrust profile 18 is configured to be engaged to rotate the cabin 12 about the cabin axis 16. An opening member (e.g. one or two doors) may be provided at an opening of the cuboid cabin 12 at a side opposite to the side of the thrust profile 18. The cabin axis 16 in FIG. 3 extends substantially through a geometrical centre of the cabin 12.

As shown in FIG. 3, the cabin 12 is rotationally supported by a chassis 14 connected at one of the sides of the cabin 12, e.g. by a swivel mount. The cabin 12 can rotate relative to the chassis 14 about the cabin axis 16. This type of cabin assembly 10 may be referred to as a box pod.

The chassis 14 in FIG. 3 is composed of two interconnecting support members in the form of linkages 44, 46. The upper linkage 44 comprises a support member 48 in the form of a plate rotatably coupled to the swivel mount of the cabin 12 for rotation about the cabin axis 16. The lower linkage 46 comprises a support member 50 in the form of a plate rotatably coupled to the swivel mount of the cabin 12 (or to the support member 48) for rotation about the cabin axis 16.

The linkages 44, 46 are further rotationally coupled to a respective wheel assembly 52 for rotation about a pivot axis 54 substantially parallel to the cabin axis 16. Each wheel assembly 52 comprises a wheel support 56 holding a plurality of wheels (e.g. six) for engaging rails of the track 28.

The chassis 14 can thereby move between an expanded state and a collapsed state. In the expanded state, the wheel assemblies 52 are brought closer to each other along the track 28 in the travel direction 58. The cabin 12 is thereby moved away from the track 28 in a direction 60 perpendicular to the travel direction 58 and is free to rotate about the cabin axis 16 without interfering with the track 28.

In the collapsed state, the wheel assemblies 52 are distanced from each other along the track 28 in the travel direction 58 such that the cabin 12 can be brought close to the track 28 (e.g. with one of the longitudinal sides of the cabin 12) to adopt a compact configuration requiring reduced elevator shaft areas. The cabin 12 can be brought to a state between the wheel assemblies 52, as seen in the travel direction 58.

With the cabin assembly 10 of FIG. 3, the cabin axis 16 coincides with the pitch axis. Although a chassis 14 comprising two linkages 44, 46 is shown, the chassis 14 may alternatively be constituted by a single rigid support member.

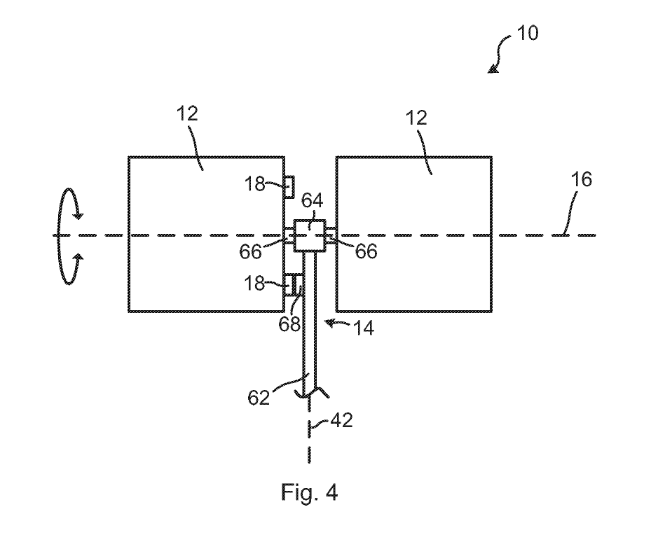

FIG. 4 schematically represents a side view of a further cabin assembly 10. This cabin assembly 10, which may be referred to as a split cabin, comprises two cabins 12 and a chassis 14 at least partly arranged between the two cabins 12.

Each cabin 12 has a substantially cuboid appearance. However, each or one of the cabins 12 may alternatively be, for example, circular or barrel shaped. The chassis 14 comprises an arm 62 arranged to rotate about the yaw axis 42. The rotation about the yaw axis 42 may however be omitted. The chassis 14 further comprises a support member 64 constituting a hub. A rod member 66, interconnecting the two cabins 12, is rotationally held by the support member 64 to allow the cabins 12 to jointly rotate about the cabin axis 16. The chassis 14 is thereby configured to rotationally support both cabins 12 for rotation about the cabin axis 16. The cabin axis 16 extends substantially through a geometrical centre of each cabin 12.

As shown in FIG. 4, only one of the cabins 12 is provided with a thrust profile 18 (both cabins 12 may however be provided with thrust profiles 18). The thrust profile 18 in FIG. 4 comprises a rotor for being engaged by a drive member 68 in the form of a stator on the chassis 14. The thrust profile 18 on one of the cabins 12 has a continuous circular shape enclosing and being concentric to the cabin axis 16 while the drive member 68 has a compact appearance that does not encircle the cabin axis 16. The thrust profile 18 and the drive member 68 are spaced along the cabin axis 16.

Although a stator and a rotor is shown in FIG. 4, this cabin assembly 10 may comprise any type of thrust profile 18 and drive member 68 according to the present disclosure to rotate the cabins 12 about the cabin axis 16.

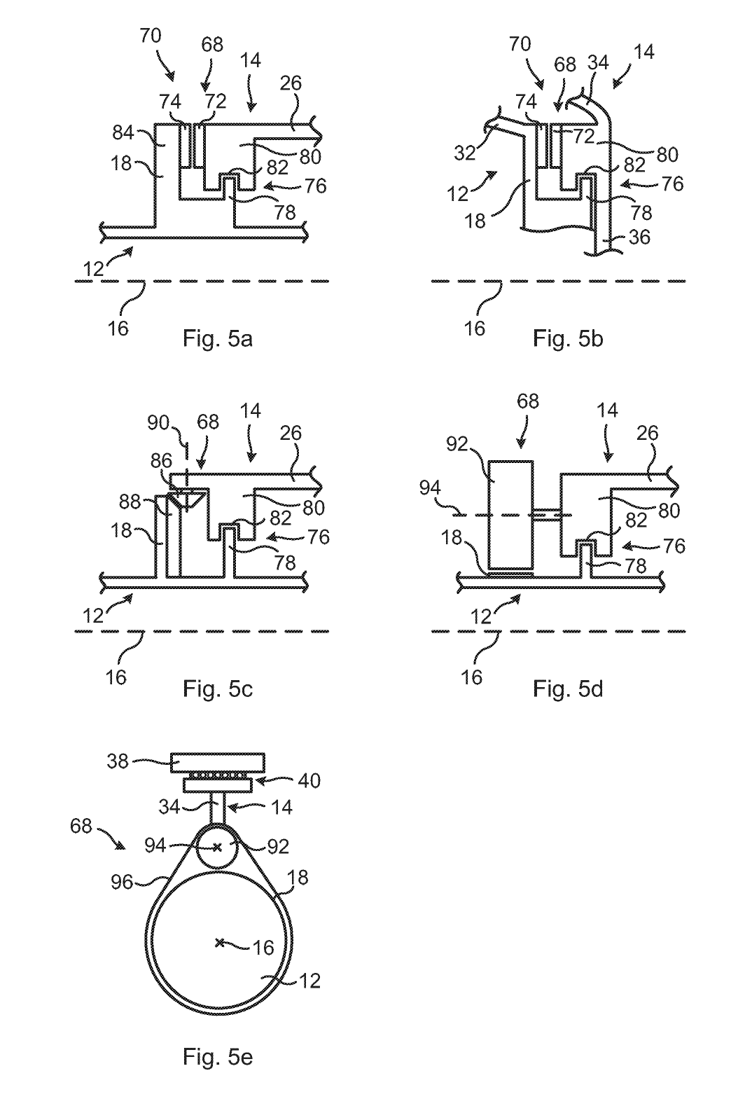

In the following, various alternative drive members 68 and thrust profiles 18 will be described with reference to FIGS. 5a to 5e. It is emphasized that FIGS. 5a to 5e merely constitute schematic representations which are not drawn to scale. For example, the distance between an upper side of the cabin 12 to the cabin axis 16 has been decreased. Moreover, hatchings have been deliberately left out in order to improve visibility.

FIG. 5a schematically represents a partial cross-sectional side view of a cabin assembly comprising an electric motor 70. In FIG. 5a, the thrust profile 18 and the drive member 68 constitute the stator 72 and the rotor 74 of an electric motor 70.

A bearing member 76 provides a rotational support for the cabin 12 for a relative rotation to the chassis 14 about the cabin axis 16. The bearing member 76 is a frictional bearing comprising two bearing surfaces.

As can be seen in FIG. 5a, the cabin 12 comprises a radially outwardly protruding flange 78 (i.e. protruding away from the cabin axis 16). The chassis 14 comprises a radially inwardly protruding collar 80. The radially outwardly protruding flange 78 (inner bearing surface) is received in a recess 82 (outer bearing surface) in the collar 80. A low frictional plastic material is provided to the bearing surfaces. Although a frictional bearing is illustrated in FIG. 5a, the bearing member 76 may alternatively be constituted by a roller bearing, a fluid bearing or an electromagnetic bearing.

A drive member 68 in the form of a stator 72 is attached to the chassis 14. More specifically, the stator 72 is attached to an axially outer side of the collar 80 of the chassis 14. The stator 72 in FIG. 5a is circular and fully encloses the cabin axis 16. However, the stator 72 does not need to enclose the cabin axis 16. The stator 72 comprises coils for producing a magnetic field.

In FIG. 5a, the thrust profile 18 is formed by a radially outwardly (with respect to the cabin axis 16) protruding collar flange 84. The thrust profile 18 is a circular disc concentric with the cabin axis 16. The thrust profile 18 is integrally formed with the cabin 12.

The thrust profile 18 comprises a rotor 74 with magnets on an axial side of the thrust profile 18 facing the stator 72. Thus, the thrust profile 18 and the drive member 68 are spaced along the cabin axis 16. The thrust profile 18 and the rotor 74 are circular and fully encloses the cabin axis 16.

By activating (i.e. electrically powering) the stator 72 provided with coils to produce a magnetic field, the rotor 74, the thrust profile 18 and consequently also the cabin 12 can be driven to rotate about the cabin axis 16. The stator 72 thus constitutes one example of a drive member 68.

FIG. 5b schematically represents a partial side cross-sectional view of a further cabin assembly 10 comprising an electric motor 70. Similar to FIG. 5a, the cabin assembly 10 in FIG. 5b comprises a drive member 68 in the form of a circular stator 72 provided on the chassis 14, a circular rotor 74 provided on the cabin 12 and a frictional bearing member 76 configured to rotationally support the cabin 12 for rotation about the cabin axis 16 relative to the chassis 14. However, instead of a thrust profile 18 provided on a radially outwardly protruding collar flange 84, the thrust profile 18 is provided on an end side of the cabin 12.

FIG. 5c schematically represents a partial side view of a further cabin assembly 10 comprising bevel gears 86, 88. Similar to FIG. 5a, the cabin assembly 10 in FIG. 5c comprises a frictional bearing member 76 configured to rotationally support the cabin 12 for rotation about the cabin axis 16 relative to the chassis 14.

However, in FIG. 5c, the drive member 68 comprises a toothed gear 86 configured to engage the thrust profile 18 to rotate the cabin 12 about the cabin axis 16. The thrust profile 18 comprises a bevel gear 88 having a rotation axis concentric with the cabin axis 16. The toothed gear 86 of the drive member 68 is also a bevel gear configured to mesh with the bevel gear 88. The bevel gear 86 is rotationally supported to the chassis 14 for rotation about a gear axis 90 substantially perpendicular to the cabin axis 16.

Thus, by rotating the bevel gear 86 about the gear axis 90, the bevel gear 88, the thrust profile 18 and consequently the cabin 12 are driven to rotate about the cabin axis 16. An electric motor may be used to drive the toothed gear 86. As can be seen in FIG. 5c, the bevel gear 88 on the thrust profile 18 may have an outer diameter substantially conforming to, or being slightly smaller than, the outer diameter of the thrust profile 18.

The bevel gear 86 may be provided on an elongated rotatable drive shaft. In case a drive member 68 comprising a bevel gear 86 provided on a drive shaft is implemented in connection with the split cabin assembly 10 in FIG. 4, the drive shaft may extend substantially parallel with, or coaxial with, the yaw axis 42. By rotating the drive shaft, the bevel gear 86 engages a bevel gear 88 on the thrust profile 18 on one of the cabins 12 to rotate both cabins 12 (the second cabin 12 can be rotated due to its rotational coupling with the first cabin 12) about the cabin axis 16.

FIG. 5d schematically represents a partial side view of a further cabin assembly 10 comprising a friction wheel 92. The thrust profile 18 in FIG. 5d is constituted by a surface facing radially outwards (with respect to the cabin axis 16). In FIG. 5d, this surface is substantially flush with the exterior profile of the cabin 12. However, the radially outwardly facing surface does not need to be flush with the exterior profile of the cabin 12. For example, in case the friction wheel 92 is used with a box pod according to FIG. 3, the friction wheel 92 may engage the radially outer surface of the circular disc (constituting the thrust profile 18) at one of the vertical sides of the cabin 12.

The surface of the thrust profile 18 is also provided with a high friction rubber material for increasing the frictional contact between the friction wheel 92 and the thrust profile 18. Also the friction wheel 92 is provided with this rubber material.

The friction wheel 92 is rotationally arranged about a friction wheel axis 94 substantially parallel with the cabin axis 16. The friction wheel 92 thus configured to engage the thrust profile 18 to rotate the cabin 12 about the cabin axis 16. Moreover, in FIG. 5d, the thrust profile 18 and the drive member 68 are spaced along an axis perpendicular to the cabin axis 16.

As an alternative design, the friction wheel 92 may be replaced by a gear wheel rotatably supported about the wheel axis 94 and the high friction rubber material on the thrust profile 18 may be replaced by radially outwardly facing teeth. By driving the gear wheel about the wheel axis 94, the radially outwardly facing teeth on the thrust profile 18 can be engaged to rotate the cabin 12 about the cabin axis 16.

FIG. 5e schematically represents a partial side view of a further cabin assembly 10 comprising a belt member 96. As can be seen, the belt member 96 is continuous and forms a closed loop around the thrust profile 18 on the cabin 12. In addition to the belt member 96, the drive member 68 also comprises a friction wheel 92 configured to drive the belt member 96. The friction wheel 92 is arranged substantially in the same manner as in FIG. 5d, i.e. rotatably arranged about a friction wheel axis 94 substantially parallel with the cabin axis 16.

The belt member 96 may be of any type suitable to engage the thrust profile 18 to rotate the cabin 12 about the cabin axis 16, such as a belt comprising rubber material. Also the thrust profile 18 may be substantially the same as in FIG. 5d, i.e. constituted by a surface facing radially outwards, for example by a surface substantially flush with the exterior profile of the cabin 12. Similar to the thrust profile 18 drivable by the friction wheel 92 in FIG. 5d, the thrust profile 18 in FIG. 5e drivable by the belt member 96 is provided with means for increasing friction.

Thus, the drive member 68 in FIG. 5e comprises a belt member 96 configured to engage the thrust profile 18 to rotate the cabin 12 about the cabin axis 16.

Although FIGS. 5a, 5c and 5d are illustrated based on the cabin assembly 10 in FIGS. 1a and 1b, any bearing member 76, drive member 68 and/or thrust profile 18 as described in connection with FIGS. 5a, 5c and 5d may also be used in each of the cabin assemblies 10 in FIGS. 2 to 4. Moreover, although FIGS. 5b and 5e are illustrated based on the cabin assembly 10 in FIG. 2, any bearing member 76, drive member 68 and/or thrust profile 18 as described in connection with FIGS. 5b and 5e may also be used in each of the cabin assemblies 10 in FIGS. 1a, 1b, 3 and 4. The arrangements shown in FIGS. 5a, 5c, 5d and 5e may be provided at any position on the cabin 12 along the cabin axis 16, in particular at a centre position.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A cabin assembly for an elevator system, the cabin assembly comprising:
a cabin,
a chassis configured to rotationally support the cabin about a cabin axis extending through the cabin, and
a circular thrust profile (18) arranged on the cabin substantially concentric to the cabin axis, and
a drive member configured to engage the thrust profile to rotate the cabin about the cabin axis,
wherein the thrust profile and the drive member are spaced along the cabin axis or spaced along an axis perpendicular to the cabin axis,
wherein the cabin axis extends substantially through a geometrical centre of the cabin.

2. The cabin assembly according to claim 1, wherein the thrust profile is continuous and fully encircles the cabin axis.

3. (canceled)

4. The cabin assembly according to claim 1, wherein the thrust profile is a circular disc substantially concentric with the cabin axis.

5. The cabin assembly according to claim 4, wherein the thrust profile protrudes radially outwards from the cabin with respect to the cabin axis.

6. The cabin assembly according to claim 4, wherein the thrust profile is arranged at an end of the cabin along the cabin axis.

7. The cabin assembly according to claim 1, wherein the cabin assembly comprises two cabins and the chassis is at least partly arranged between the two cabins.

8. The cabin assembly according to claim 1, further comprising at least one bearing member configured to allow relative rotation of the cabin and the chassis about the cabin axis.

9. The cabin assembly according to claim 1, further comprising a bearing member associated with each thrust profile and wherein each bearing member is distanced from an associated thrust profile.

10. The cabin assembly according to claim 1, wherein the thrust profile and the drive member constitute a stator and a rotor of an electric motor.

11. The cabin assembly according to claim 1, wherein the drive member comprises at least one toothed gear configured to engage the thrust profile to rotate the cabin about the cabin axis.

12. The cabin assembly according to claim 11, wherein the thrust profile and the drive member comprise bevel gears.

13. The cabin assembly according to claim 1, wherein the drive member comprises at least one friction wheel configured to engage the thrust profile to rotate the cabin about the cabin axis.

14. The cabin assembly according to claim 1, wherein the drive member comprises a belt member configured to engage the thrust profile to rotate the cabin about the cabin axis.

15. An elevator system comprising a cabin assembly according to claim 1.
